(19) United States
(12) Patent Application Publication
(10) Pub. No.: US 2023/0251658 A1
(43) Pub. Date: Aug. 10, 2023

(54) SELF-AWARE MOBILE SYSTEM

(71) Applicant: Newton Howard, Potomac, MD (US)

(72) Inventor: Newton Howard, Potomac, MD (US)

(21) Appl. No.: 18/194,281

(22) Filed: Mar. 31, 2023

Related U.S. Application Data
(63) Continuation-in-part of application No. 17/524,407, filed on Nov. 11, 2021.
(60) Provisional application No. 63/325,997, filed on Mar. 31, 2022.
(60) Provisional application No. 63/250,207, filed on Sep. 29, 2021.

(51) Int. Cl. G05D 1/00; G05D 1/02; G05D 1/10; B64C 39/02

(52) U.S. Cl. CPC G05D 1/0088; G05D 1/021; G05D 1/101; B64C 39/024; G05D 2201/0209; B64U 2101/15

(57) ABSTRACT

Embodiments may provide techniques for operating autonomous systems with improved autonomy so as to operate largely or completely, autonomously. For example, in an embodiment, a self-aware mobile system may comprise a vehicle, vessel, or aircraft comprising: at least one communication device configured to transmit and receive data so as communicate with at least one autonomous sensor platform, and at least one computer system configured to receive data from the at least one autonomous sensor platform and, using the received data, to generate data to implement autonomous movement corresponding to SAE automation level 4 or level 5 using processing in accordance with a Hierarchical Intelligence Model and to generate data to communicate with a human regarding operations of the vehicle, vessel, or aircraft, and at least one autonomous sensor platform comprising: at least one communication device configured to transmit and receive data so as communicate with the vehicle, vessel, or aircraft.

### CROSS-REFERENCE TO RELATED APPLICATIONS

This application claims the benefit of U.S. Provisional Application No. 63/325,997, filed Mar. 31, 2022, and is a continuation-in-part of U.S. patent application Ser. No. 17/524,407, filed Nov. 11, 2021, which claims the benefit of U.S. Provisional Application No. 63/250,207, filed Sep. 29, 2021, the contents of all of which are incorporated herein in their entirety.

### BACKGROUND

The present invention relates to techniques for operating autonomous systems with improved autonomy so as to operate largely, or even completely, autonomously.

Autonomous systems are system that perform behaviors or tasks with a high degree of autonomy. Conventional theories and technologies of autonomous systems emphasize human-system interactions and humans in-the-loop, and so are not completely, or even mainly, autonomous.

Accordingly, a need arises for autonomous systems with improved autonomy so as to operate largely, or even completely, autonomously.

### SUMMARY

Embodiments of the present systems and methods may provide techniques for operating autonomous systems with improved autonomy so as to operate largely, or even completely, autonomously. Embodiments may utilize computational input and output on the structural and behavioral properties that constitute the intelligence power of human autonomous systems. Embodiments may utilize vision and image and visual processing at the core as input. Embodiments may utilize collected vision data as the intelligence aggregates from reflexive, imperative, adaptive elements to manage the intelligence for an autonomous self-driving system. Embodiments may utilize a Hierarchical Intelligence Model (HIM) to elaborate the evolution of human and system intelligence as an inductive process used in car and vehicle systems. Embodiments may utilize a set of properties used for system autonomy that is formally analyzed and used towards a wide range of autonomous system applications in computational intelligence and systems engineering.

For example, Unmanned Aircraft Systems (UAS) drones may provide advance collection of imaging and Vision data. This data may be used as feedback into the vehicle system allowing advance awareness and decision support for automated guidance and collision avoidance.

For example, in an embodiment, a self-aware mobile system may comprise a vehicle, vessel, or aircraft comprising: at least one communication device configured to transmit and receive data so as communicate with at least one autonomous sensor platform, and at least one computer system configured to receive data from the at least one autonomous sensor platform and, using the received data, to generate data to implement autonomous movement corresponding to SAE automation level 4 or level 5 using processing in accordance with a Hierarchical Intelligence Model and to generate data to communicate with a human regarding operations of the vehicle, vessel, or aircraft, and at least one autonomous sensor platform comprising: at least one communication device configured to transmit and receive data so as communicate with the vehicle, vessel, or aircraft.

In embodiments, the at least one autonomous sensor platform may be an unmanned aerial vehicle. The vehicle, vessel, or aircraft may be a military or tactical vehicle and the generated data may be text or voice data to communicate with a human vehicle commander regarding when normal operations of a vehicle escalate into a combat response. The generated data may be generated by logic and algorithmic machine learning to detect threat patterns based on an environment of the military or tactical vehicle. The military or tactical vehicle may be part of a multi-vehicle swarm and the generated data provides combination and coordination with multiple units and levels of units. The at least one autonomous sensor platform may be a ground drone.

In an embodiment, a method of implementing self-aware mobile system may comprise receiving data from at least one autonomous sensor platform at a vehicle, vessel, or aircraft comprising at least one computer system comprising a processor, memory accessible by the processor, and computer program instructions stored in the memory and executable by the processor, generating, at the computer system, data to implement autonomous movement corresponding to SAE automation level 4 or level 5 using processing in accordance with a Hierarchical Intelligence Model, using the received data and generating data to communicate with a human regarding operations of the vehicle, vessel, or aircraft, and implementing autonomous movement of the vehicle, vessel, or aircraft using the generated data.

In an embodiment, a computer program product comprising a non-transitory computer readable storage having program instructions embodied therewith, the program instructions executable by a computer comprising a processor, memory accessible by the processor, and computer program instructions stored in the memory and executable by the processor, to cause the computer to perform a method comprising: receiving data from at least one autonomous sensor platform at a vehicle, vessel, or aircraft comprising the computer system, generating, at the computer system, data to implement autonomous movement corresponding to SAE automation level 4 or level 5 using processing in accordance with a Hierarchical Intelligence Model, using the received data and generating data to communicate with a human regarding operations of the vehicle, vessel, or aircraft, and implementing autonomous movement of the vehicle, vessel, or aircraft using the generated data.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 illustrates an exemplary block diagram of a system in which embodiments of the present systems and methods may be implemented.

FIG. 2 is an exemplary block diagram of a system, which may be included in one or more self-aware mobile systems according to embodiments of the present systems and methods.

FIG. 3 is an example of operation of embodiments of the present systems and methods.

FIG. 4 is an exemplary diagram of the SAE standard levels of automation for vehicles according to embodiments of the present systems and methods.

FIG. 5 is an exemplary diagram of the natural and machine intelligence underpinning autonomous systems may be inductively generated through data, information, and knowledge according to embodiments of the present systems and methods.

FIG. 6 is an exemplary illustration of A hierarchical intelligence model (HIM) created for identifying the levels of intelligence and their difficulty for implementation in computational intelligence based on the abstract intelligence (αI) theory according to embodiments of the present systems and methods.

FIG. 7 is an exemplary diagram of Autonomous Systems implementing nondeterministic, context-dependent, and adaptive behaviors according to embodiments of the present systems and methods.

FIG. 8 is an exemplary block diagram of a computer system, in which processes involved in the embodiments described herein may be implemented.

### DETAILED DESCRIPTION

Embodiments of the present systems and methods may provide techniques for autonomous systems with improved autonomy so as to operate largely, or even completely, autonomously. Embodiments may utilize computational input and output on the structural and behavioral properties that constitute the intelligence power of human autonomous systems. Embodiments may utilize vision and image and visual processing at the core as input. Embodiments may utilize collected vision data as the intelligence aggregates from reflexive, imperative, adaptive elements to manage the intelligence for an autonomous self-driving system. Embodiments may utilize a Hierarchical Intelligence Model (HIM) to elaborate the evolution of human and system intelligence as an inductive process used in car and vehicle systems. Embodiments may utilize a set of properties used for system autonomy that is formally analyzed and used towards a wide range of autonomous system applications in computational intelligence and systems engineering.

For example, Unmanned Aircraft Systems (UAS) drones may provide advance collection of imaging and Vision data. This data may be used as feedback into the vehicle system allowing advance awareness and decision support for automated guidance and collision avoidance.

As another example, ground-based military or other tactical vehicles may require certain navigational, targeting, and team communication decisions within a forward looking 120 second environment. In embodiments, logic and algorithmic machine learning may inform a vehicle commander of threat patterns based on the environment. The vehicle may implement persistent awareness to generate text or voice data to communicate with a human vehicle commander regarding when normal operations of a vehicle escalate into a combat response. In embodiments, the vehicle may process and analyze data transmitted over RF frequencies and may extract specific data elements that are transmitted over these frequencies. Event monitoring and alerting may include event analysis, visual learning, and role specific decision support. For example, a use-case may include IED hunting.

One of the issues with visual learning may be an overabundance of visual learning, which may cause impairment to team members' cognitive load. In embodiments, areas of current learning may be replaced by the outputs of analytical models. In embodiments, the decision support provided to a commander by our model is intended to support the independent operation of the commander's vehicle alone or may consider automation of action across a multi-vehicle swarm?

Supervised autonomy may be implemented to provide configuration and modification of automated decision making for, for example, a commander, driver and gunner of a vehicle. The system may be updated to include additional candidates for further automation. The autonomy level for a vehicle may likewise be configured for desired autonomy levels.

Examples of military and tactical use-cases may include multi-vehicle swarms, such as a 25-vehicle swarm. Further use cases may include using the generated data to provide combination and coordination with multiple units and levels of units, such as squad and platoon combination and coordination.

Further, communications may be provided using RF-based communications and alternatively or in addition alternatives to RF-based communications, such as forward-deployed private network/5g communications.

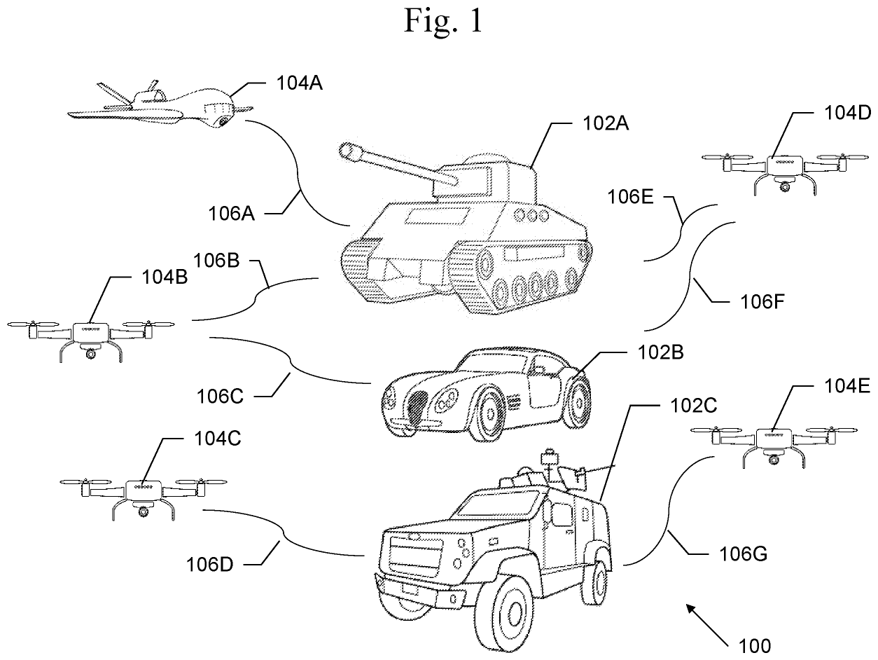

An exemplary block diagram of a system 100, in which embodiments of the present systems and methods may be implemented is shown in FIG. 1. In this example, system 100 may include one or more self-aware mobile systems 102A-C, one or more autonomous sensor platforms 104A-E, and communications links 106A-G. Self-aware mobile systems 102A-C may be any type or configuration of terrestrial, nautical, submarine, or aeronautic vehicle, such as automobiles, trucks, tanks, boats, ships, aircraft, etc. Autonomous sensor platforms 104A-E may include long, medium, and short endurance platforms, such as Unmanned Aerial Vehicles (UAVs), ground drones, etc. For example, long endurance platforms, such as drone 104A may be launched and recovered from external facilities, such as airfields, and controlled by external controllers or autonomous control. Medium and short endurance platforms may likewise be launched and recovered from external facilities, or may be stored in, and launched and recovered from, or in conjunction with self-aware mobile systems 102A-C.

Communications links 106A-G may provide communications between self-aware mobile systems 102A-C and autonomous sensor platforms 104A-E, as well as among individual autonomous sensor platforms 104A-E. Communications links 106A-G are typically wireless links, such as radio frequency (RF) link, optical links, acoustic links, etc. Communications links 106A-G may be encrypted so as to provide secure communications between and among self-aware mobile systems 102A-C and autonomous sensor platforms 104A-E. Using such encryption, communications may be limited to communications between individual self-aware mobile systems 102A-C and autonomous sensor platforms 104A-E, between selected pluralities of self-aware mobile systems 102A-C and autonomous sensor platforms 104A-E, or between all authorized self-aware mobile systems 102A-C and autonomous sensor platforms 104A-E.

Self-aware mobile systems 102A-C and autonomous sensor platforms 104A-E may further be in communication with non-autonomous sensor platforms, such as aircraft, vessels, and other vehicles, and may be in communication with non-terrestrial sensor and/or information providers, such as satellites, for example, surveillance satellites, weather satellites, GPS satellites, etc.

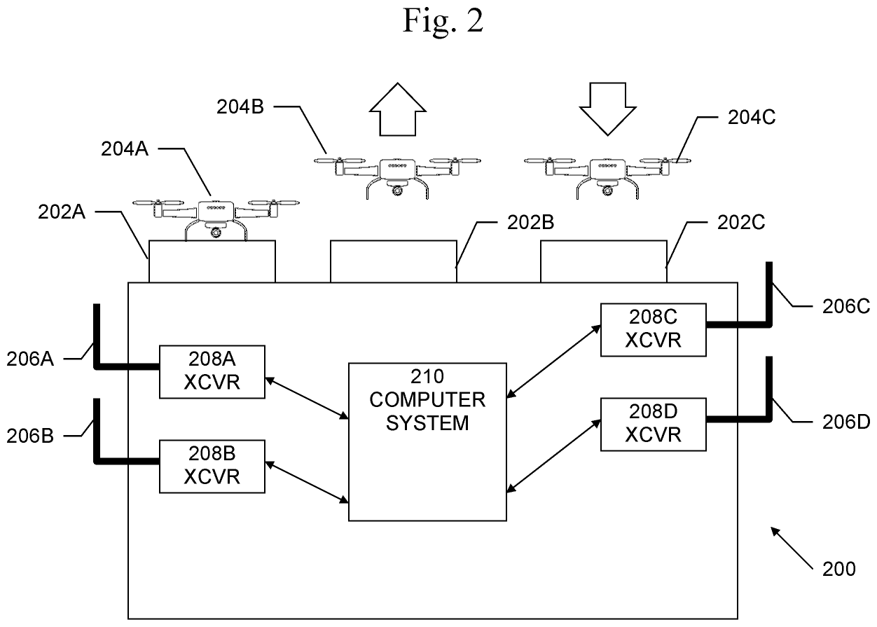

An exemplary block diagram of a system 200, which may be included in one or more self-aware mobile systems 102A-C is shown in FIG. 2. System 200 may include one or more attachment and charging/refueling points 202A-C, which may be used to store and charge/refuel 204A autonomous sensor platforms, launch 204B autonomous sensor platforms, and recover 204C autonomous sensor platforms. System 200 may further include a plurality of antennas 206A-D, which may be connected to transceivers 208A-D, and which together may provide communications of commands, status data, telemetry data, and sensor data with autonomous sensor platforms 204A-C. System 200 may further include computer system 210, which may receive and process status data, telemetry data, and sensor data from autonomous sensor platforms 204A-C, process and forward generate and process status data, telemetry data, and sensor data received from autonomous sensor platforms to other status data, telemetry data, and sensor data from autonomous sensor platforms, generate commands to autonomous sensor platforms 204A-C, and generate intelligent behaviors for one or more self-aware mobile systems using, for example, Hierarchical Intelligence Model (HIM) processing, described below. Likewise, autonomous sensor platforms 204A-C may utilize their own generated status data, telemetry data, and sensor data, status data, telemetry data, and sensor data received from other autonomous sensor platforms, and processed status data, telemetry data, and sensor data, and commands received from one or more self-aware mobile systems and may generate intelligent behaviors for itself using, for example, HIM processing, described below.

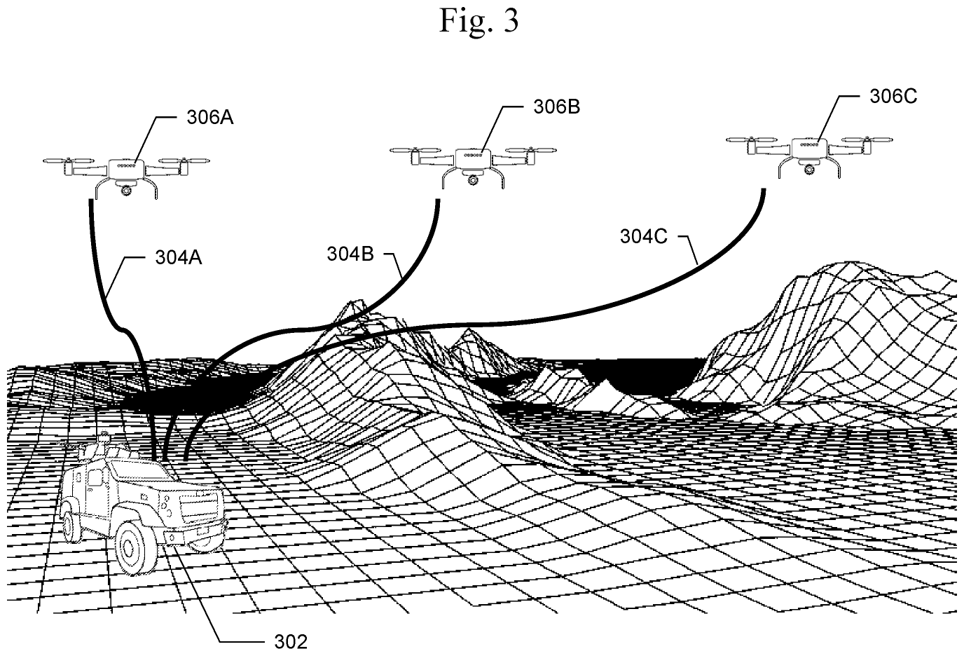

An example of operation of embodiments of the present systems and methods is shown in FIG. 3. In this example, self-aware mobile system 302 may be in communication 304A-C with autonomous sensor platforms 306A-C. Autonomous sensor platforms 306A-C may provide the capability to sense conditions surrounding self-aware mobile system 302, including in the immediate vicinity of self-aware mobile system 302, as well as more distant conditions. Such conditions may include, for example, the presence and location of terrain, structures, vehicles, vessels, aircraft, persons, etc. More distant conditions may include, for example, conditions obscured by obstacles, such as other vehicles, structures, terrain, etc., as well as conditions too remote to ordinarily be sensed from self-aware mobile system 302, such as over terrain, over-the-horizon, etc.

Although embodiments have been described in terms of self-aware mobile systems and drone autonomous sensor platforms, the present techniques are equally applicable to other embodiments as well. For example, the focal point may be a self-aware mobile system 302, other vehicles, water-going vessels, aircraft, or fixed installations, such as buildings. Autonomous sensor platforms may include drones, whether long, medium, or short endurance, as well as sensors mounted on other vehicles, vessels, aircraft, satellites, etc., as long as data from the sensor platforms is communicated to the focal point, such as self-aware mobile system 302. Autonomous sensor platforms may include sensor such as cameras, LIDAR, RADAR, radiation detectors, chemical detectors, etc., an any other type of condition sensor that may be available.

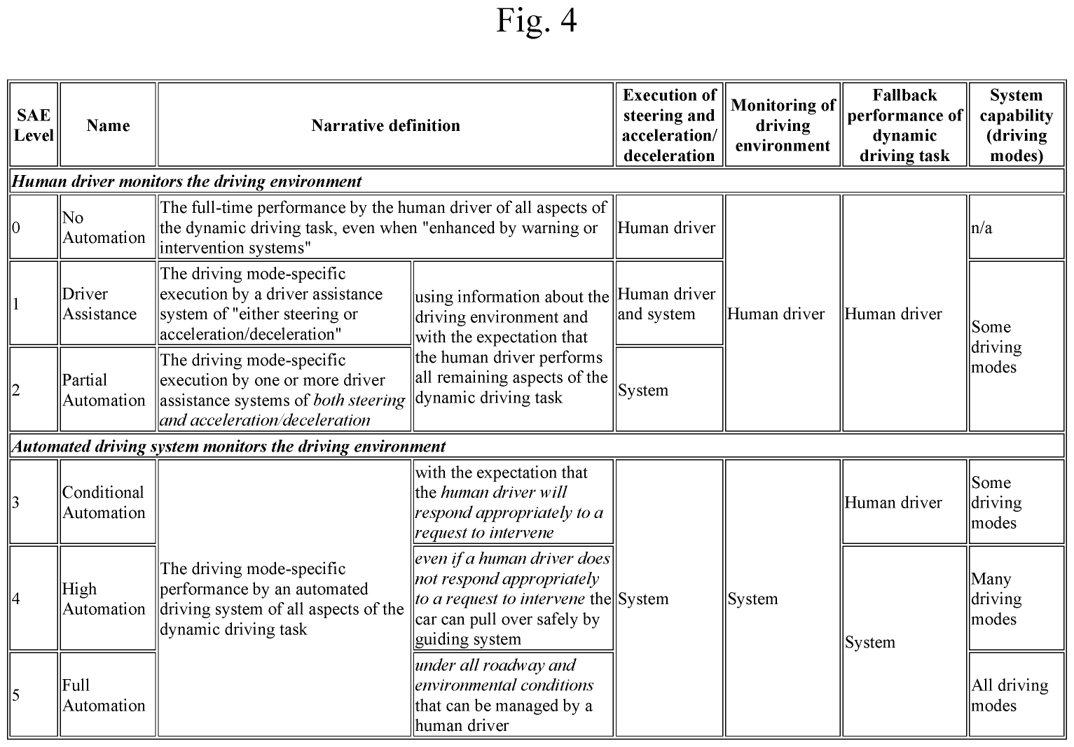

An exemplary diagram of the SAE standard levels of automation for vehicles is shown in FIG. 4. Even though this example shows levels of automation for vehicles being driven, the automation levels themselves are applicable to operation of any type of vehicle, vessel, aircraft, etc. In embodiments, the present techniques may provide level 4 and level 5 automation for vehicles, vessels, aircraft, etc. using HIM processing, described below.

Hierarchical Intelligence Model (HIM) processing. Autonomous systems (AS) used to be perceived as an Internet protocol in industry. Machine learning and control theories focus on human-system interactions in AS' where humans are in-the-loop cooperating with the machine. NATO refers AS to a system that “exhibits goal-oriented and potentially unpredictable and non-fully deterministic behaviors.

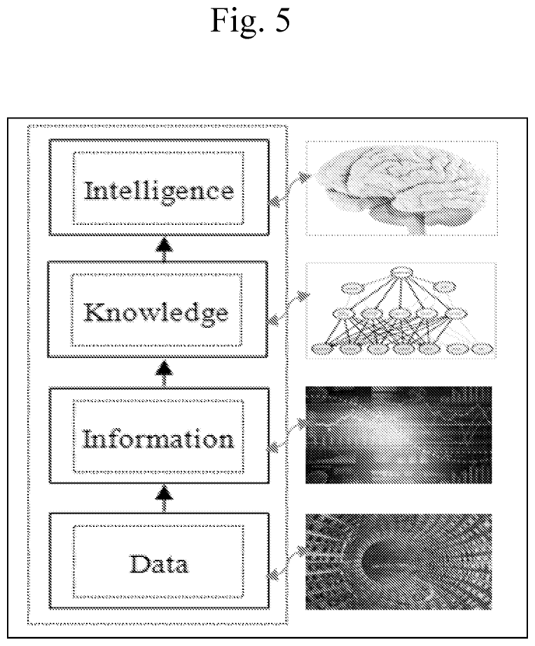

The natural and machine intelligence underpinning autonomous systems may be inductively generated through data, information, and knowledge as illustrated in FIG. 5 from the bottom up. FIG. 5 indicates that intelligence may not be directly aggregated from data as some neural network technologies inferred, because there are multiple inductive layers from data to intelligence. Therefore, a matured AS would be expected to be able to independently discover a law in sciences (inductive intelligence) or autonomously comprehend the semantics of a joke in natural languages (inference intelligence). None of them is trivial in order to extend the AS' intelligence power beyond data aggregation abilities.

Intelligence is the paramount cognitive ability of humans that may be mimicked by computational intelligence and cognitive systems. Intelligence science studies the general form of intelligence, formal principles and properties, as well as engineering applications. This section explores the cognitive and intelligent foundations of AS underpinned by intelligence science.

The intension and extension of the concept of intelligence, C₁(intelligence), may be formally described by a set of attributes (A₁) and of objects (O₁) according to concept algebra:

$$( 1 )$$

$${C}_{1} ( intelligence : {A}_{1} , {O}_{1} , {R}_{1}^{c} , {R}_{1}^{i} , {R}_{1}^{o} ) = \{ \begin{matrix}\begin{matrix}{A}_{1} = \\ \{ {cognitive\_object}^{*} , mental\_power , \\ aware\_to \_be , able\_to \_do , process , execution , \\ transfer\_information \_to \_knowledge , \\ transfer\_information \_to \_behaviour \}\end{matrix} \\ {O}_{1} = \{ brain , robots , {natural}_{i} , AI , {animal}_{i} , \\ {reflexive}_{i} , {imperative}_{i} , {adaptive}_{i} , \\ {autonomous}_{i} , {cognitive}_{i} \} \\ {R}_{1}^{c} = {O}_{1} \times {A}_{1} \\ {R}_{1}^{i} ⊆ \times {C}_{1} \\ {R}_{1}^{o} ⊆ {C}_{1} \times \end{matrix}$$

where R₁^{c}, R₁ⁱ, and R₁^{o} represent the sets of internal and input/output relations of C₁ among the objects and attributes or from/to existing knowledge [symbol] as the external context.

Definition 1. Intelligence [symbol] is a human, animal, or system ability that autonomously transfers a piece of information I into a behavior B or an item of knowledge K, particularly the former, i.e.:

[symbol]

=f_{to-do}:I→B

[symbol]

=f_{to-be}:I→K (2)

Intelligence science is a contemporary discipline that studies the mechanisms and properties of intelligence, and the theories of intelligence across the neural, cognitive, functional, and mathematical levels from the bottom up.

A classification of intelligent systems may be derived based on the forms of inputs and outputs dealt with by the system as shown in Table 1. The reflexive and imperative systems may be implemented by deterministic algorithms or processes. The adaptive systems can be realized by deterministic behaviors constrained by the predefined context. However, AS is characterized as having both varied inputs and outputs where its inputs must be adaptive, and its outputs have to be rationally fine-tuned to problem-specific or goal-oriented behaviors.

TABLE 1
Classification of autonomous and nonautonomous systems

Behavior (O)

| | | Constant | Varied |
|---|---|---|---|
| Stimulus (I) | Constant | Reflexive | Adaptive |
| | Varied | Imperative | Autonomous |

According to Definition 1 and Table 1, AS is a highly intelligent system for dealing with variable events by flexible and fine-tuned behaviors without the intervention of humans.

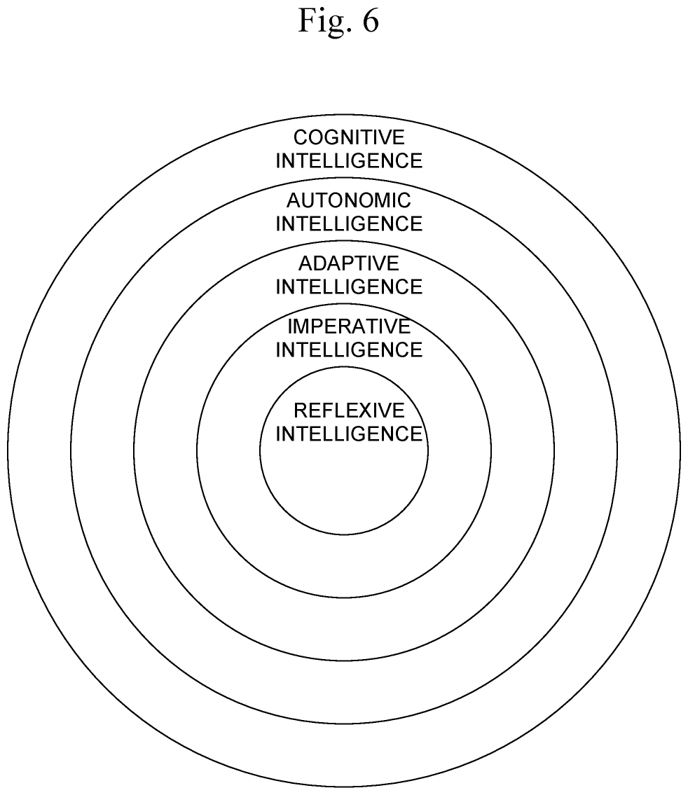

The Hierarchical Model of Intelligence. A hierarchical intelligence model (HIM) is created for identifying the levels of intelligence and their difficulty for implementation in computational intelligence as shown in FIG. 6 based on the abstract intelligence (αI) theory. In HIM, the levels of intelligence are aggregated from reflexive, imperative, adaptive, autonomous, and cognitive intelligence with 16 categories of intelligent behaviors. Types of system intelligence across the HIM layers are formally described in the following subsections using the stimulus/event-driven formula as defined in Eq. 2.

Reflexive Intelligence. Reflexive intelligence [symbol] _{ref} is the bottom-layer intelligence coupled by a stimulus and a reaction. [symbol] _{ref} is shared among humans, animals, and machines, which forms the foundation of higher layer intelligence.

Definition 2. The reflexive intelligence [symbol] _{ref} is a set of wired behaviors B_{ref} directly driven by specifically coupled external stimuli or trigger events @ₑ_{ᵢ}|REF, i.e.:

$${ref}_{} \hat{=} {{R}^{{n}_{ref}}}_{i = 1} @ {e}_{i} \vert REF {B}_{ref} ( i ) \vert PM \qquad ( 3 )$$

where the big-R notation is a mathematical calculus that denotes a sequence of iterative behaviors or a set of recurring structures, [symbol] is a dispatching operator between an event and a specified function, @ the event prefix of systems, |REF the string suffix of a reflexive event, and |PM the process model suffix.

Imperative Intelligence Imperative intelligence [symbol] ᵢₘₚ is a form of instructive and reflective behaviors dispatched by a system based on the layer of reflexive intelligence. [symbol] ᵢₘₚ encompasses event-driven behaviors (Bᵢₘₚ^{e}), time-driven behaviors(Bᵢₘₚ^{t}), and interruptdriven behaviors (Bᵢₘₚ^{int}).

Definition 3. The event-driven intelligence [symbol] ᵢₘₚ^{e} is a predefined imperative behavior Bᵢₘₚ^{e} driven by an event @ₑ_{ᵢ}|E, such as:

$${imp}_{e}^{} \hat{=} {{R}^{{n}_{e}}}_{i = 1} @ {e}_{i} \vert E {B}_{imp}^{e} ( i ) \vert PM \qquad ( 4 )$$

Definition 4. The time-driven intelligence [symbol] ᵢₘₚ^{t} is a predefined imperative behavior Bᵢₘₚ^{t} driven by a point of time @ₑ_{ᵢ}|TM, such as:

$${imp}_{t}^{} \hat{=} {{R}^{{n}_{t}}}_{i = 1} @ {e}_{i} \vert TM {B}_{imp}^{t} ( i ) \vert PM \qquad ( 5 )$$

where @ₑ_{ᵢ}|TM may be a system or external timing event.

Definition 5. The interrupt-driven intelligence [symbol] ᵢₘₚ^{int} is a predefined imperative behavior Bᵢₘₚ^{int} driven by a system triggered interrupt event @ei| [symbol] , such as:

$${imp}_{int}^{} \hat{=} {{R}^{{n}_{int}}}_{i = 1} @ {e}_{i} \vert ⊙ {B}_{imp}^{int} ( i ) \vert PM \qquad ( 6 )$$

where the interrupt, @intᵢ| [symbol] , triggers an embedded process, B₁|PM [symbol] B₂|PM=B₁|PM∥(eᵢₙₜⁱ|⊙ [symbol] B₂|PM [symbol] ⊙), where the current process B₁ is temporarily held by a higher priority process B₂ requested by the interrupt event at the interrupt point [symbol] . The interrupted process will be resumed when the high priority process has been completed. The imperative system powered by [symbol] ᵢₘₚ is not adaptive, and may merely implement deterministic, context-free, and stored program controlled behaviors.

Adaptive Intelligence. Adaptive intelligence [symbol] _{adp} is a form of run-time determined behaviors where a set of predictable scenarios is determined for processing variable problems. [symbol] _{adp} encompasses analogy-based behaviors (B_{adp}^{ab}), feedback-modulated behaviors (B_{adp}^{fm}), and environment-awareness behaviors (B_{adp}^{ea}).

Definition 6. The analogy-based intelligence [symbol] _{adp}^{ab} is a set of adaptive behavior B_{adp}^{ab} that operate by seeking an equivalent solution for a given request @ₑ_{ᵢ}|RQ, such as:

$${adp}_{ab}^{} \hat{=} {{R}^{{n}_{ab}}}_{i = 1} @ {e}_{i} \vert RQ {B}_{adp}^{ab} ( i ) \vert PM \qquad ( 7 )$$

Definition 7. The feedback-modulated intelligence [symbol] _{adp}^{fm} is a set of adaptive behaviors B_{adp}^{fm} rectified by the feedback of temporal system output @ₑ_{ᵢ}|FM, such as:

$${adp}_{fm}^{} \hat{=} {{R}^{{n}_{fm}}}_{i = 1} @ {e}_{i} \vert FM {B}_{adp}^{fm} ( i ) \vert PM \qquad ( 8 )$$

Definition 8. The environment-awareness intelligence [symbol] _{adp}^{ea} is a set of adaptive behavior B_{adp}^{ea} where multiple prototype behaviors are modulated by the change of external environment @ₑ_{ᵢ}|EA, such as:

$${adp}_{ea}^{} \hat{=} {{R}^{{n}_{ea}}}_{i = 1} @ {e}_{i} \vert EA {B}_{adp}^{ea} ( i ) \vert PM \qquad ( 9 )$$

[symbol] _{ada} is constrained by deterministic rules where the scenarios are prespecified. If a request is out of the defined domain of an adaptive system, its behaviors will no longer be adaptive or predictable.

Autonomous Intelligence. Autonomous intelligence [symbol] ₐᵤₜ is the fourth-layer intelligence powered by internally motivated and self-generated behaviors underpinned by senses of system consciousness and environment awareness. [symbol] ₐᵤₜ encompasses the perceptive behaviors (Bₐᵤₜ^{pe}), problem-driven behaviors(Bₐᵤₜ^{pd}), goal oriented behaviors (Bₐᵤₜ^{go}), decision-driven behaviors (Bₐᵤₜ^{dd}), and deductive behaviors (Bₐᵤₜ^{de}) built on the Layers 1 through 3 intelligent behaviors.

Definition 9. The perceptive intelligence [symbol] ₐᵤₜ^{pe} is a set of autonomous behaviors Bₐᵤₜ^{pe} based on the selection of a perceptive inference @ₑ_{ᵢ}|PE, such as:

$${aut}_{pe}^{} \hat{=} {{R}^{{n}_{e}}}_{i = 1} @ {e}_{i} \vert PE {B}_{aut}^{pe} ( i ) \vert PM \qquad ( 10 )$$

Definition 10. The problem-driven intelligence [symbol] ₐᵤₜ^{pd} is a set of autonomous behaviors Bₐᵤₜ^{pd} that seeks a rational solution for the given problem @ₑ_{ᵢ}|PD, such as:

$${aut}_{pd}^{} \hat{=} {{R}^{{n}_{pd}}}_{i = 1} @ {e}_{i} \vert PD {B}_{aut}^{pd} ( i ) \vert PM \qquad ( 11 )$$

Definition 11. The goal-oriented intelligence [symbol] ₐᵤₜ^{go} is a set of autonomous behaviors Bₐᵤₜ^{go} seeking an optimal path towards the given goal @ₑ_{ᵢ}|GO, such as:

$${aut}_{go}^{} \hat{=} {{R}^{{n}_{go}}}_{i = 1} @ {e}_{i} \vert GO {B}_{aut}^{go} ( i ) \vert PM \qquad ( 12 )$$

where the goal, g|SM=(P, Ω, θ), is a structure model (SM) in which P is a finite nonempty set of purposes or motivations, Ω a finite set of constraints to the goal, and θ the environment of the goal.

Definition 12. A decision-driven intelligence [symbol] ₐᵤₜ^{dd}, is a set of autonomous behaviors Bₐᵤₜ^{dd} driven by the outcome of a decision process @ₑ_{ᵢ}|DD, such as:

$${aut}_{dd}^{} \hat{=} {{R}^{{n}_{dd}}}_{i = 1} @ {e}_{i} \vert DD {B}_{aut}^{dd} ( i ) \vert PM \qquad ( 13 )$$

where the decision, d|SM=(A,C), is a structure model in which A is a finite nonempty set of alternatives, and C a finite set of criteria.

Definition 13. The deductive intelligence if [symbol] ₐᵤₜ^{de} is a set of autonomous behaviors Bₐᵤₜ^{de} driven by a deductive process @ₑ_{ᵢ}|DE based on known principles, such as:

$${aut}_{de}^{} \hat{=} {{R}^{{n}_{de}}}_{i = 1} @ {e}_{i} \vert DE {B}_{aut}^{de} ( i ) \vert PM \qquad ( 14 )$$

[symbol]

ₐᵤₜ is self-driven by the system based on internal consciousness and environmental awareness beyond the deterministic behaviors of adaptive intelligence. [symbol] ₐᵤₜ represents nondeterministic, context-dependent, run-time autonomic, and self-adaptive behaviors.

Cognitive Intelligence. Cognitive intelligence [symbol] _{cog} is the fifth-layer of intelligence that generates inductive- and inference-based behaviors powered by autonomous reasoning. [symbol] _{cog} encompasses the knowledge-based behaviors (B_{cog}^{kb}), learning-driven behaviors (B_{cog}^{id}), inference-driven behaviors (B_{cog}^{if}), and inductive behaviors (B_{cog}^{id}) built on the intelligence powers of Layers 1 through 4.

Definition 14. The knowledge-based intelligence [symbol] _{cog}^{kb} is a set of cognitive behaviors B_{cog}^{kb} generated by introspection of acquired knowledge @ₑ_{ᵢ}|KB

$${cog}_{kb}^{} \hat{=} {{R}^{{n}_{kb}}}_{i = 1} @ {e}_{i} \vert KB {B}_{cog}^{kb} ( i ) \vert PM \qquad ( 15 )$$

Definition 15. The learning-driven intelligence [symbol] _{cog}^{id} is a set of cognitive behaviors B_{cog}^{ld} generated by both internal introspection and external searching @ₑ_{ᵢ}|LD, such as:

$${cog}_{ld}^{} \hat{=} {{R}^{{n}_{ld}}}_{i = 1} @ {e}_{i} \vert LD {B}_{cog}^{ld} ( i ) \vert PM \qquad ( 16 )$$

Definition 16. The inference-driven intelligence [symbol] _{cog}^{if} is a set of cognitive behaviors B_{cog}^{if} that creates a causal chain from a problem to a rational solution driven by @ₑ_{ᵢ}|IF, such as:

$${cog}_{if}^{} \hat{=} {{R}^{{n}_{if}}}_{i = 1} @ {e}_{i} \vert IF {B}_{cog}^{if} ( i ) \vert PM \qquad ( 17 )$$

Definition 17. The inductive intelligence [symbol] _{cog}^{id} is a set of cognitive behaviors B_{cog}^{id} that draws a general rule based on multiple observations or common properties @ₑ_{ᵢ}|ID, such as:

$${cog}_{id}^{} \hat{=} {{R}^{{n}_{id}}}_{i = 1} @ {e}_{i} \vert ID {B}_{cog}^{id} ( i ) \vert PM \qquad ( 18 )$$

[symbol] _{cog} is nonlinear, nondeterministic, context-dependent, knowledge-dependent, and self-constitute, which represents the highest level of system intelligence mimicking the brain. [symbol] _{cog} indicates the ultimate goal of AI and machine intelligence. The mathematical models of HIM indicate that the current level of machine intelligence has been stuck at the level of [symbol] _{adp} for the past 60 years. One would rarely find any current AI system that is fully autonomous comparable to the level of human natural intelligence.

THE THEORY OF AUTONOMOUS SYSTEMS. On the basis of the HIM models of intelligence science as elaborated in the preceding section, autonomous systems will be derived as a computational implementation of autonomous intelligence aggregated from the lower layers.

Properties of System Autonomy and Autonomous Systems. According to the HIM model, autonomy is a property of intelligent systems that “can change their behavior in response to unanticipated events during operation” “without human intervention.”

Definition 18. The mathematical model of an AS is a high-level intelligent system for implementing advanced and complex intelligent abilities compatible to human intelligence in systems, such as:

$$AS \hat{=} {{R}^{{n}_{AS}}}_{i = 1} @ {e}_{AS}^{i} \vert S [ {B}_{AS} ( i ) \vert PM \vert {B}_{AS} ( i ) \vert PM \geq 4 ] \qquad ( 19 )$$

which extends system intelligent power from reflexive, imperative, and adaptive to autonomous and cognitive intelligence.

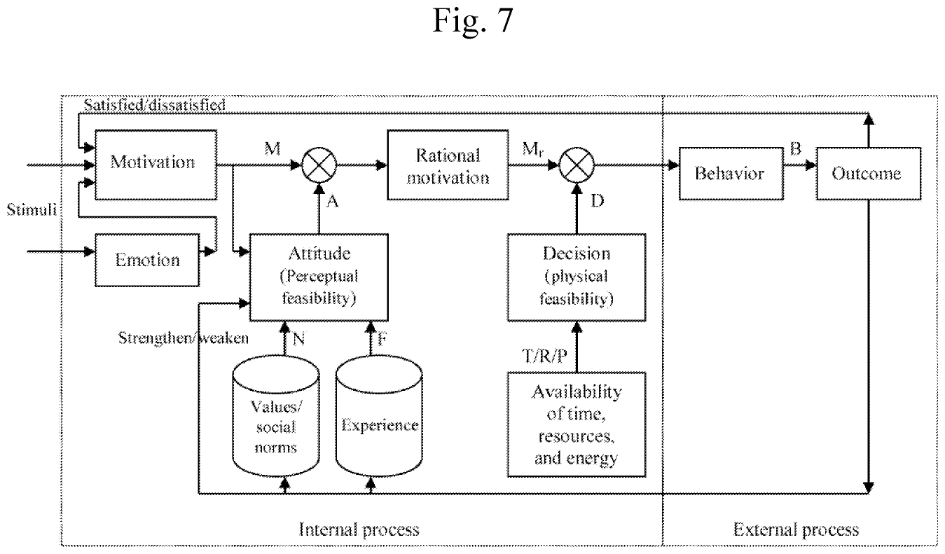

AS implements nondeterministic, context-dependent, and adaptive behaviors. AS is a nonlinear system that depends not only on current stimuli or demands, but also on internal status and willingness formed by long-term historical events and current rational or emotional goals (see FIG. 7). The major capabilities of AS will need to be extended to the cognitive intelligence level towards highly intelligent systems beyond classic adaptive and imperative systems.

Lemma 1. The behavioral model of AS, AS|§, is inclusively aggregated from the bottom up, such as:

$$AS \vert § \hat{=} ( {B}_{Ref} , {B}_{Imp} , {B}_{Adp} , {B}_{Aut} , {B}_{Cog} ) = \{ ( {B}_{rf} ) // {B}_{Ref} ‖ ( {B}_{e} , {B}_{t} , {B}_{int} ) ⋃ {B}_{Ref} // {B}_{Imp} ‖ ( {B}_{ab} , {B}_{fm} , {B}_{ea} ) ⋃ {B}_{Imp} ⋃ {B}_{Ref} // {B}_{Ada} ‖ ( {B}_{pe} , {B}_{pd} , {B}_{go} , {B}_{dd} , {B}_{de} ) ⋃ {B}_{Adp} ⋃ {B}_{Imp} ⋃ {B}_{Ref} // {B}_{Aut} ‖ ( {B}_{kb} , {B}_{ld} , {B}_{if} , {B}_{id} ) ⋃ {B}_{Aut} ⋃ {B}_{Adp} ⋃ {B}_{Imp} ⋃ {B}_{Ref} // {B}_{Cog} \} \qquad ( 20 )$$

where ∥ denotes a parallel relation, |§ the system suffix, and each intelligent behavior has been formally defined above.

Proof. Lemma 1 can be directly proven based on the definitions in the HIM model.

Theorem 1. The relationships among all levels of intelligent behaviors as formally modeled in HIM are hierarchical (a) and inclusive (b), i.e.:

$$HIM \vert § \hat{=} \{ \begin{matrix}a ) {{R}^{4}}_{k = 1} {B}^{k} ( {B}^{k - 1} ) , {B}^{0} = {{R}^{{n}_{ref}}}_{i = 1} @ {e}_{i} \vert REF {B}_{ref} ( i ) \vert PM \\ b ) {B}_{Cog} ⊇ {B}_{Aut} ⊇ {B}_{Ada} ⊇ {B}_{Imp} ⊇ {B}_{Ref}\end{matrix} \qquad ( 21 )$$

Proof. According to Lemma 1, a) Since

$${{R}^{4}}_{k = 1} {B}^{k} ( {B}^{k - 1} )$$

in Eq. 21(a) aggregates B⁰ through B⁴ hierarchically, the AS can be deductively reduced from the top down as well as inductively composed from the bottom up when B⁰ is deterministic; b) Since Eq. 21(b) is a partial order, it is inclusive between adjacent layers of system intelligence from the bottom up.

Theorem 1 indicates that any lower layer behavior of an AS is a subset of those of a higher layer. In other words, any higher layer behavior of AS is a natural aggregation of those of lower layers as shown in FIG. 6 and Eqs. 20/21. Therefore, Theorem 1 and Lemma 1 reveals the necessary and sufficient condition of AS.

The Effect of Human in Hybrid Autonomous Systems Because the only matured paradigm of AS is the brain, advanced AS is naturally open to incorporate human intelligence as indicated by the HIM model. This notion leads to a broad form of hybrid AS with coherent human-system interactions. Therefore, human factors play an irreplaceable role in hybrid AS in intelligence and system theories.

Definition 19. Human factors are the roles and effects of humans in a hybrid AS that introduces special strengths, weaknesses, and/or uncertainty.

The properties of human strengths in AS are recognized such as highly matured autonomous behaviors, complex decision-making, skilled operations, comprehensive senses, flexible adaptivity, perceptive power, and complicated system cooperation. However, the properties of human weaknesses in AS are identified such as low efficiency, tiredness, slow reactions, error-proneness, and distraction. In addition, a set of human uncertainty in AS is revealed such as productivity, performance, accuracy, reaction time, persistency, reliability, attitude, motivation, and the tendency to try unknown things even if they are prohibited.

We found that human motivation, attitude, and social norms (rules) may affect human perceptive and decision making behaviors as well as their trustworthiness as shown in FIG. 7 by the Autonomous Human Behavior Model (AHBM). AHBM illustrates the interactions of human perceptive behaviors involving emotions, motivations, attitudes, and decisions. In the AHBM model, a rational motivation, decision and behavior can be quantitatively derived before an observable action is executed. The AHBM model of humans in AS may be applied as a reference model for trustworthy decision-making by machines and cognitive systems.

According to Theorem 1 and Lemma 1, a hybrid AS with humans in the loop will gain strengths towards the implementation of cognitive intelligent systems. The cognitive AS will sufficiently enable a powerful intelligent system by the strengths of both human and machine intelligence. This is what intelligence and system sciences may inspire towards the development of fully autonomous systems in highly demanded engineering applications.

CONCLUSION It has been recognized that autonomous systems are characterized by the power of perceptive, problem-driven, goal-driven, decision-driven, and deductive intelligence, which are able to deal with unanticipated and indeterministic events in real-time. This work has explored the intelligence and system science foundations of autonomous systems. A Hierarchical Intelligence Model (HIM) has been developed for elaborating the properties of autonomous systems built upon reflexive, imperative, and adaptive systems. The nature of system autonomy and human factors in autonomous systems has been formally analyzed. This work has provided a theoretical framework for developing cognitive autonomous systems towards highly demanded engineering applications including brain-inspired cognitive systems, unmanned systems, self-driving vehicles, cognitive robots, and intelligent IoTs.

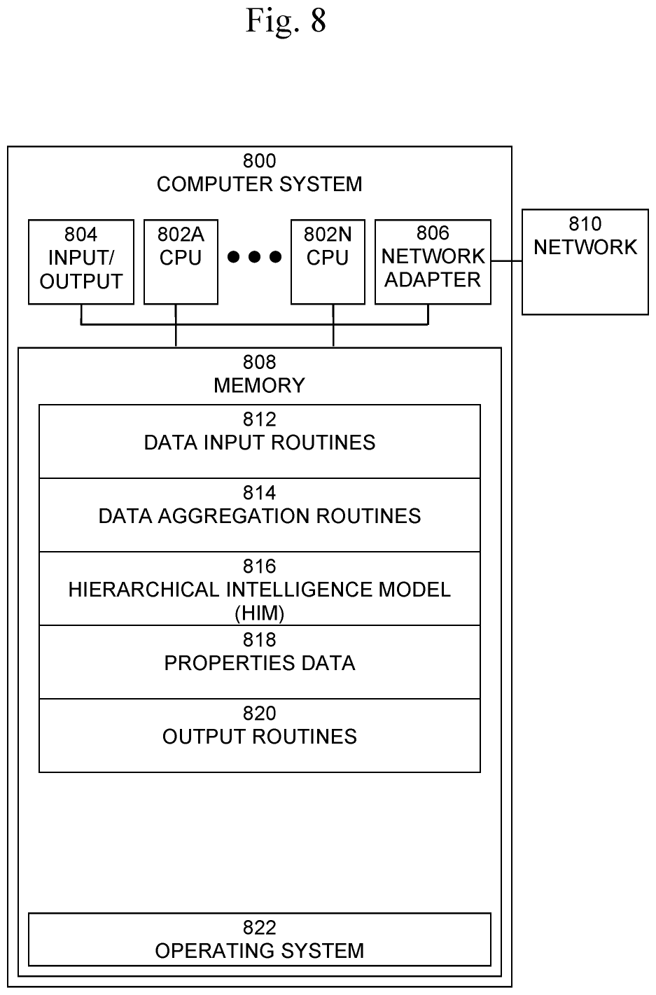

An exemplary block diagram of a computer system 800, in which processes involved in the embodiments described herein may be implemented, is shown in FIG. 8. Computer system 802 may be implemented using one or more programmed general-purpose computer systems, such as embedded processors, systems on a chip, personal computers, workstations, server systems, and minicomputers or mainframe computers, or in distributed, networked computing environments. Computer system 802 may include one or more processors (CPUs) 802A-802N, input/output circuitry 804, network adapter 806, and memory 808. CPUs 802A-802N execute program instructions in order to carry out the functions of the present communications systems and methods. Typically, CPUs 802A-802N are one or more microprocessors, such as an INTEL CORE® processor. FIG. 8 illustrates an embodiment in which computer system 802 is implemented as a single multi-processor computer system, in which multiple processors 802A-802N share system resources, such as memory 808, input/output circuitry 804, and network adapter 806. However, the present communications systems and methods also include embodiments in which computer system 802 is implemented as a plurality of networked computer systems, which may be single-processor computer systems, multi-processor computer systems, or a mix thereof.

Input/output circuitry 804 provides the capability to input data to, or output data from, computer system 802. For example, input/output circuitry may include input devices, such as keyboards, mice, touchpads, trackballs, scanners, analog to digital converters, etc., output devices, such as video adapters, monitors, printers, etc., and input/output devices, such as, modems, etc. Network adapter 806 interfaces device 800 with a network 810. Network 810 may be any public or proprietary LAN or WAN, including, but not limited to the Internet.

Memory 808 stores program instructions that are executed by, and data that are used and processed by, CPU 802 to perform the functions of computer system 802. Memory 808 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 808 may vary depending upon the function that computer system 802 is programmed to perform. In the example shown in FIG. 8, exemplary memory contents are shown representing routines and data for embodiments of the processes described above. For example, FIG. 8 includes memory contents for both a client 812 and a server 814. However, one of skill in the art would recognize that these routines, along with the memory contents related to those routines, may not be included on one system or device, but rather may be distributed among a plurality of systems or devices, based on well-known engineering considerations. The present systems and methods may include any and all such arrangements.

In the example shown in FIG. 8, memory 808 may include memory contents for self-aware mobile systems and autonomous sensor platforms. Memory contents may include data input routines 812, data aggregation routines 814, Hierarchical Intelligence Model (HIM) routines 816, properties data 818, output routines 820, and operating system 822. Data input routines 812 may include software to accept input data from sensors attached to autonomous sensor platforms or received from autonomous sensor platforms. Data aggregation routines 814 may include software to accept input data and process and aggregate such data for use by self-aware mobile systems and autonomous sensor platforms. Hierarchical Intelligence Model (HIM) routines 816 may include software to process data, generate commands to autonomous sensor platforms, and generate intelligent behaviors for one or more self-aware mobile systems and/or autonomous sensor platforms so as to elaborate the evolution of human and system intelligence as an inductive process. Properties data 818 may include a set of properties used for system autonomy that may be formally analyzed and used towards a wide range of autonomous system applications in computational intelligence and systems engineering. Output routines 820 may include software to generate and output signals to actuate and implement generated commands to autonomous sensor platforms, and generated intelligent behaviors for one or more self-aware mobile systems and/or autonomous sensor platforms. Operating system 822 may provide overall system functionality.

As shown in FIG. 8, the present communications systems and methods may include implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including Linux, UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A self-aware mobile system comprising:
a vehicle, vessel, or aircraft comprising:
at least one communication device configured to transmit and receive data so as communicate with at least one autonomous sensor platform, and
at least one computer system configured to receive data from the at least one autonomous sensor platform and, using the received data, to generate data to implement autonomous movement corresponding to SAE automation level 4 or level 5 using processing in accordance with a Hierarchical Intelligence Model and to generate data to communicate with a human regarding operations of the vehicle, vessel, or aircraft; and
at least one autonomous sensor platform comprising:
at least one communication device configured to transmit and receive data so as communicate with the vehicle, vessel, or aircraft.

2. The system of claim 1, wherein the at least one autonomous sensor platform is an unmanned aerial vehicle.

3. The system of claim 1, wherein the vehicle, vessel, or aircraft is a military or tactical vehicle and the generated data is text or voice data to communicate with a human vehicle commander regarding when normal operations of a vehicle escalate into a combat response.

4. The system of claim 3, wherein the generated data is generated by logic and algorithmic machine learning to detect threat patterns based on an environment of the military or tactical vehicle.

5. The system of claim 3, wherein the military or tactical vehicle is part of a multi-vehicle swarm and the generated data provides combination and coordination with multiple units and levels of units.

6. The system of claim 1, wherein the at least one autonomous sensor platform is a ground drone.

7. A method of implementing self-aware mobile system comprising:
receiving data from at least one autonomous sensor platform at a vehicle, vessel, or aircraft comprising at least one computer system comprising a processor, memory accessible by the processor, and computer program instructions stored in the memory and executable by the processor;
generating, at the computer system, data to implement autonomous movement corresponding to SAE automation level 4 or level 5 using processing in accordance with a Hierarchical Intelligence Model, using the received data and generating data to communicate with a human regarding operations of the vehicle, vessel, or aircraft; and
implementing autonomous movement of the vehicle, vessel, or aircraft using the generated data.

8. The method of claim 7, wherein the at least one autonomous sensor platform is an unmanned aerial vehicle.

9. The method of claim 7, wherein the vehicle, vessel, or aircraft is a military or tactical vehicle and the generated data is text or voice data to communicate with a human vehicle commander regarding when normal operations of a vehicle escalate into a combat response.

10. The method of claim 9, wherein the generated data is generated by logic and algorithmic machine learning to detect threat patterns based on an environment of the military or tactical vehicle.

11. The method of claim 9, wherein the military or tactical vehicle is part of a multi-vehicle swarm and the generated data provides combination and coordination with multiple units and levels of units.

12. The method of claim 7, wherein the at least one autonomous sensor platform is a ground drone.

13. A computer program product comprising a non-transitory computer readable storage having program instructions embodied therewith, the program instructions executable by a computer comprising a processor, memory accessible by the processor, and computer program instructions stored in the memory and executable by the processor, to cause the computer to perform a method comprising:
receiving data from at least one autonomous sensor platform at a vehicle, vessel, or aircraft comprising the computer system;
generating, at the computer system, data to implement autonomous movement corresponding to SAE automation level 4 or level 5 using processing in accordance with a Hierarchical Intelligence Model, using the received data and generating data to communicate with a human regarding operations of the vehicle, vessel, or aircraft; and
implementing autonomous movement of the vehicle, vessel, or aircraft using the generated data.

14. The computer program product of claim 13, wherein the at least one autonomous sensor platform is an unmanned aerial vehicle.

15. The computer program product of claim 13, wherein the vehicle, vessel, or aircraft is a military or tactical vehicle and the generated data is text or voice data to communicate with a human vehicle commander regarding when normal operations of a vehicle escalate into a combat response.

16. The computer program product of claim 15, wherein the generated data is generated by logic and algorithmic machine learning to detect threat patterns based on an environment of the military or tactical vehicle.

17. The computer program product of claim 16, wherein the military or tactical vehicle is part of a multi-vehicle swarm and the generated data provides combination and coordination with multiple units and levels of units.

18. The computer program product of claim 13, wherein the at least one autonomous sensor platform is a ground drone.
